(19) United States
(12) Patent Application Publication
(10) Pub. No.: US 2026/0286759 A1
(43) Pub. Date: Sep. 24, 2026

(54) ADJUSTABLE SWINGING COVER ASSEMBLY FOR COVERING A MANHOLE OF A STEAM GENERATOR

(71) Applicant: AKTIEBOLAGET SKF, GOTEBORG (SE)

(72) Inventor: Didier DECLERCK, Acheres (FR)

(21) Appl. No.: 19/564,467

(22) Filed: Mar. 12, 2026

(30) Foreign Application Priority Data
Mar. 21, 2025 (DE) 102025110945.1

(51) Int. Cl. E05F 15/53

(52) U.S. Cl. CPC E05F 15/53; E05Y 2900/00

(57) ABSTRACT

An adjustable swinging cover assembly is for covering a manhole of a steam generator and includes a fixed axle, a cover and a cover swinging frame for rotating around the fixed axle and provided with a base beam and a frame. The base beam is rotatably mounted on the fixed axle, the frame being slidably mounted on the base beam and securing the cover. The cover swinging frame further includes a jack attached to the base beam and adapted to slide the frame with respect to the base beam.

### CROSS-REFERENCE

This application claims priority to German patent application no. 102025110945.1 filed on March 21, 2025, the contents of which are fully incorporated herein by reference.

### BACKGROUND OF THE INVENTION

The present invention relates to positioning mechanisms, and more particularly to an adjustable swinging cover assembly for covering a manhole of a steam generator and an associated method for adjusting the cover of such an adjustable swinging cover assembly.

In nuclear power plants using Pressurized Water Reactor or PWR technology, heat is provided by an intermediate heat transfer fluid which transfers heat from a nuclear reactor core to a steam generator.

Periodically, it is necessary to gain access to the interior of such steam generators, for example to carry out checking and maintenance operations.

Access is gained by means of manholes which have a diameter that is just large enough to allow a service person wearing a protective suit to pass through without undue difficulty.

Outside of checking and maintenance operations, each manhole is closed by a cover that ensures the watertightness of the steam generator.

Usually, such a cover is heavy, typically over 600 kg, and it is difficult for the maintenance personnel to manipulate the cover during the opening and closing of the manholes.

Furthermore, it is often required to minimize the downtime so as to limit the operator dosimetry.

However, the positioning of the cover relative to the steam generator is generally not very precise and the maintenance personnel often have to spend excessive time in order to obtain a correct position when closing the cover.

### SUMMARY OF THE INVENTION

Therefore, there is a need to provide a solution that meets the above requirements and which makes it possible to ensure a swift and precise manipulation of the cover.

The present invention relates to a cover swinging frame for covering a manhole of a steam generator, the cover being provided with a base beam and a frame, the base beam being intended to be rotatably mounted on a fixed axle of the steam generator, the frame being intended to secure a manhole cover of the steam generator.

The frame is slidably mounted on the base beam, the cover swinging frame further comprising a jack attached to the base beam and adapted to slide the frame with respect to the base beam.

Such a cover swinging frame enables a swift and precise adjustment of the cover position allowing a controlled pushing of the cover into a closed cover position. For example, the frame is slidably mounted on a pair of base cylinders fixed to the base beam.

In some embodiments, the frame is provided with two opposite parallel arms intended to secure the cover, each arm being slidably mounted inside a borehole provided on each base cylinder.

Preferably, each base cylinder comprises a stop limiting the frame slide to a fixed predetermined maximal value. Preferably, each base cylinder comprises a locking pin that locks the frame in position with respect to the base cylinder.

For example, the base beam is provided with a recess that receives the jack.

According to another aspect, the invention relates to an adjustable swinging cover assembly comprising a manhole cover, a fixed axle and a cover swinging frame as defined above.

Advantageously, the base beam is slidably mounted on the fixed axle. This configuration allows the adjustment of the base beam position with respect to the fixed axle.

In a set of embodiments, the adjustable swinging cover assembly is provided with positioning means preventing the sliding of the base beam with regards to the fixed axle. Such positioning means ensure a correct base beam position. For example, the positioning means comprise a pair of nuts.

According to another aspect, the invention relates to a method for adjusting the cover of an adjustable swinging cover assembly as defined above, by using the jack to push the cover into a closed cover position.

### BRIEF DESCRIPTION OF THE SEVERAL VIEWS OF THE DRAWINGS

The present invention and its advantages will be better understood by studying the detailed description of specific embodiments given by way of a non-limiting examples and illustrated by the appended drawings on which:

FIG. 1 is a perspective view of a manipulator and an adjustable swinging cover assembly according to an example of the invention;

FIG. 2 is a side view of the manipulator and the adjustable swinging cover assembly of FIG. 1; and

FIG. 3 is a bottom view of the adjustable swinging cover assembly of FIG. 1 in a nearly closed cover position.

### DETAILED DESCRIPTION OF THE INVENTION

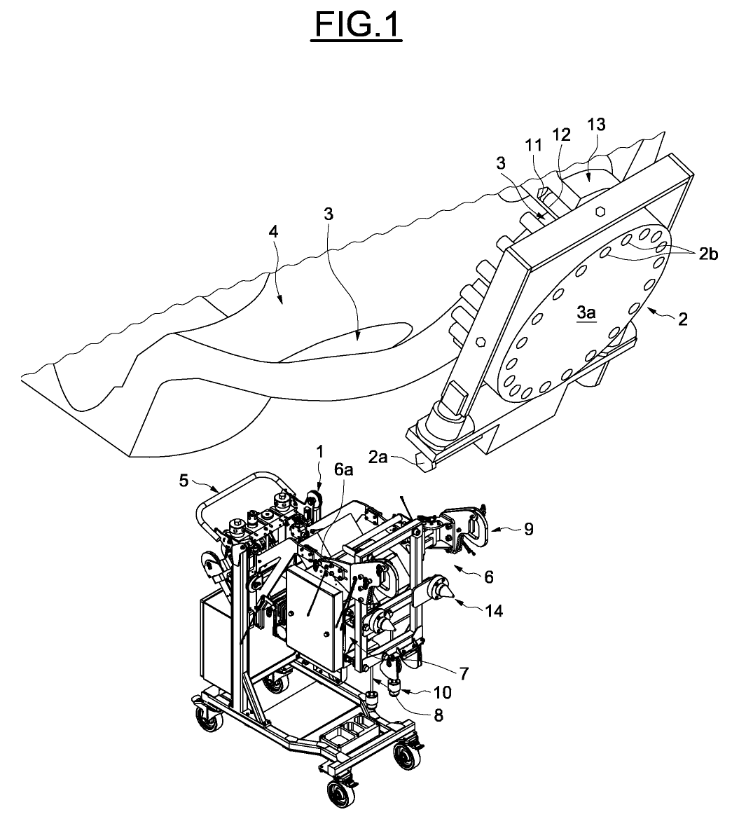

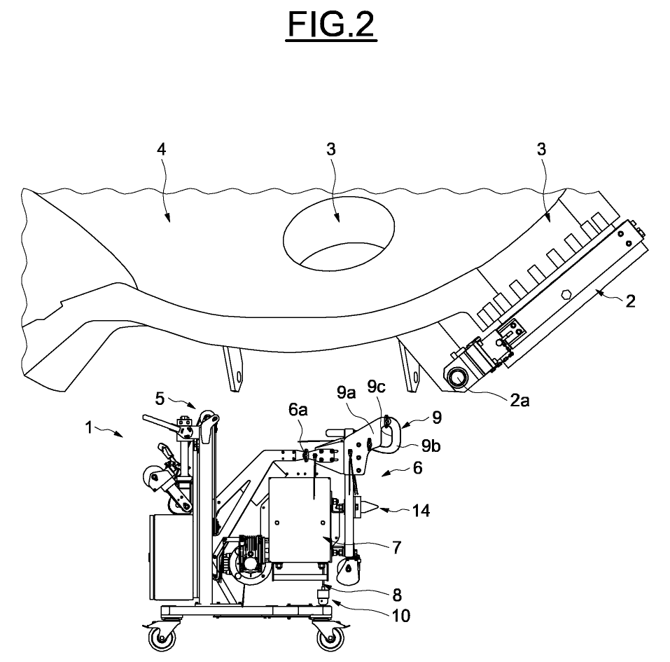

A manipulator 1 is represented in FIGS. 1 and 2 and is adapted to open and to close an adjustable swinging cover assembly 2 adapted to cover a manhole 3 of a steam generator 4 of a nuclear plant.

The adjustable swinging cover assembly 2 comprises a fixed axle 2a, a manhole cover 3a and a cover swinging frame 14 that is configured to rotate around the fixed axle 2a between a closed cover position and an open cover position. The axle 2a is fixed to the steam generator 4 and is essentially coplanar with the cover swinging frame 14.

The manipulator 1 basically comprises a hand trolley assembly 5 and a winch assembly 6.

The winch assembly 6 is detachably mounted to the hand trolley assembly 5, for example with a pair of removable ball lock pins 6a that allow or enable the winch assembly to rotate freely. The winch assembly 6 includes a winch 7 provided with a pair of wires 8. The winch assembly 6 is intended to engage the adjustable swinging cover assembly 2 and is further provided with a pair of hooks 9 intended to hang the winch assembly 6 on the fixed axle 2a. The winch assembly 6 is provided with two threaded anchors 10, each anchor 10 being attached to an end of one of the wires 8 and being intended to pass through a first through hole 2b of the adjustable swinging cover assembly 2 and to be fastened to an inner thread 11 of a second hole 12 provided on a base plate 13 of the steam generator 4 so as to provide a support point for the associated wire 8.

The winch 7 is adapted to tension or to slacken the wires 8 in order to rotate the cover swinging frame 14 around the fixed axle 2a between the closed cover position in which the first through hole 2b is aligned with the second hole 12 and the open cover position in which the cover swinging frame 14 is at a neutral hanging point.

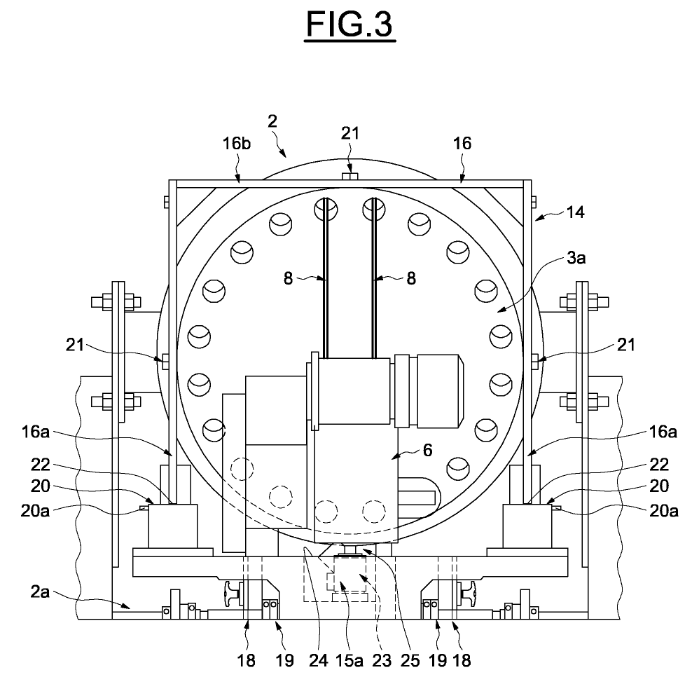

As particularly shown in FIG. 3, the cover swinging frame 14 is provided with a base beam 15 and a frame 16.

It is to be noted that elements that are similar or identical are identified with the same references throughout the different figures.

The base beam 15 is rotatably mounted on the axle 2a so that the base beam 15 is able to, or configured to, rotate around the axle 2a.

The base beam 15 is slidably mounted on the fixed axle 2a so that the base beam 15 is able to slide along the fixed axle 2a. For example, the base beam 15 is provided with a through-hole which receives the fixed axle 2a and that has an inner surface that corresponds to an outer surface of the fixed axle 2a. As such, the fixed axle 2a serves as a linear guiding rod for the base beam 15. Preferably, the adjustable swinging cover assembly 2 is provided with positioning means 18 preventing the sliding of the base beam 15 with regards to the fixed axle 2a. For example, the positioning means 18 include a plurality of nuts 19.

The frame 16 is slidably mounted on the base beam 15 so that the frame 16 is able to slide or slidably displace with respect to the base beam 15. More precisely, the frame 16 is slidably mounted on a pair of base cylinders 20 that are fixed to the base beam 15.

The frame 16 is provided with two opposite parallel arms 16a and with a transverse beam 16b extending between the two arms 16a. The arms 16a and the transverse beam 16b secure the cover 3a with fastening means 21. For example, the fastening means 21 include a plurality of nuts and bolts fixing the cover 3a to the frame 16.

Each arm 16a is slidably mounted inside a borehole 22 provided on each base cylinder 20 so that the frame 16 and the cover 3a are able to slide together with respect to the base cylinders 20 and to the base beam 15.

Advantageously, each base cylinder 20 comprises a stop limiting the frame 16 slide to a fixed predetermined maximum value. In other words, the stop limits an amount of sliding displacement of the frame 16 to the predetermined maximum value.

As particularly shown in FIG. 3, each base cylinder 20 includes a locking pin 20a that locks the frame 16 in position with respect to the base cylinder 20.

The cover swinging frame 14 further comprises a jack 23 attached to the base beam 15 and adapted to slide the cover 3a and the frame 16 with respect to the base cylinders 20 and to the base beam 15. For example, the jack 23 is a bottle jack provided with a hydraulic ram that pushes against the cover 3a. The jack 23 enables a precise adjustment of a position of the cover 3a and allows a controlled pushing of the cover 3a into the closed cover position.

Preferably, the base beam 15 is provided with a recess 24 that receives the jack 23.

As shown in FIG. 3, the jack 23 is provided on a central part 15a of the base beam 15 at an essentially equal distance between the two arms 16a allowing a symmetrical push of the frame 16 and cover 3a. The jack 23 contacts a lateral face 25 of the cover 3a.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A cover swinging frame for covering a manhole of a steam generator, the cover swinging frame comprising:
a base beam configured to be rotatably mounted on a fixed axle of the steam generator;
a frame configured to secure a manhole cover of the steam generator and being slidably mounted on the base beam; and
a jack attached to the base beam and adapted to slide the frame with respect to the base beam.

2. The cover swinging frame according to claim 1, further comprising a pair of base cylinders fixed to the base beam, the frame being slidably mounted on the pair of base cylinders.

3. The cover swinging frame according to claim 2, wherein the frame includes two opposite parallel arms configured to secure the cover, each one of the two parallel arms being slidably mounted inside a borehole provided in each one of the pair of base cylinders.

4. The cover swinging frame according to claim 2, wherein each one of the pair of base cylinders includes a stop configured to limit an amount of frame displacement to a fixed predetermined maximum value.

5. The cover swinging frame according to claim 2, wherein each one of the pair of base cylinders includes a locking pin that locks the frame in position with respect to the base cylinder.

6. The cover swinging frame according to claim 1, wherein the base beam has a recess that receives the jack.

7. An adjustable swinging cover assembly comprising:
a manhole cover;
a fixed axle; and
a cover swinging frame according to claim 1.

8. The adjustable swinging cover assembly according to claim 7, wherein the base beam is slidably mounted on the fixed axle.

9. The adjustable swinging cover assembly according to claim 8, further comprising positioning means configured to prevent sliding of the base beam with respect to the fixed axle.

10. A method for adjusting the cover of an adjustable swinging cover assembly according to claim 7, the method comprising the step of:
operating the jack to push the cover into a closed cover position.
